(19) United States
(12) Patent Application Publication
(10) Pub. No.: US 2009/0169880 A1
(43) Pub. Date: Jul. 2, 2009

(54) OVERLAID PANEL WITH AN IMPROVED COEFFICIENT OF FRICTION

(75) Inventors: Christopher R. Scoville, Flint Hill, VA (US); David R. Willis, Bishop, GA (US)

Correspondence Address: Gardner Groff Greenwald & Villanueva, PC, 2018 Powers Ferry Road, Suite 800, Atlanta, GA, 30339, US

(73) Assignee: Huber Engineered Woods LLC, Charlotte, NC (US)

(21) Appl. No.: 12/340,316

(22) Filed: Dec. 19, 2008

Related U.S. Application Data
(60) Provisional application No. 61/018,278, filed on Dec. 31, 2007.

(51) Int. Cl. B32B 7/12; B32B 37/00

(52) U.S. Cl. 428/354; 156/60

(57) ABSTRACT

A overlaid panel with an improved coefficient of friction is described which comprises a textured resin top surface layer, an overlay layer, and a bottom panel layer wherein the COF is improved relative to conventional overlaid panels or bare panels without the textured resin top surface layer.

### CROSS-REFERENCE TO RELATED APPLICATIONS

This application claims the benefit of U.S. Provisional Application No. 61/018,278, filed Dec. 31, 2007, hereby incorporated by reference in its entirety for its teachings of the invention.

### BACKGROUND

One of the difficulties of working on roofs or with roofing is the obvious problem of having a high enough coefficient of friction (COF) to work on and provide a sufficient level of safety. The dangers to workmen while working on roofs are generally known. These workers assume various positions on a roof and can easily fall either on the roof or from the roof if sufficiently gripping surface is not available. This danger is especially high before shingles and the like are installed on the roof.

Overlaid roofing panels can be used for constructing the underlying roofing structure. The overlay bonded to the panel may actually make a panel harder to work upon in some instances since it may cover any surface roughness on the underlying panel. Thus, one goal with some overlaid panels is to increase their COF.

ZIP System® roof sheathing (Huber Engineered Woods LLC, Charlotte, N.C.; www.huberwood.com) is a commercially available overlaid panel which has been successful in meeting the performance requirements of the acceptance criteria for building code organizations. In general, customers are pleased with how it performs as well. However, one constructive criticism that is heard consistently is that the customers would like a surface that is less slippery to walk upon. The roof panels are usually installed on sloped roofs of 2:12 to 18:12 pitch, and as the slope increases, there is a greater need for more slip-resistance.

Therefore, a need exists for methods and materials that provide increased slip resistance/higher coefficient of friction on structural panels such as roofing panels.

### SUMMARY OF THE INVENTION

Described herein is a structural panel with an improved coefficient of friction comprising a textured resin top surface layer, an overlay layer, and a bottom panel layer. The textured resin top surface layer comprises a resin glueline with an imprinted texture effective to increase the COF relative to panels without a top textured resin surface layer. The overlay layer can comprise a resin-impregnated overlay web material. The bottom panel layer can comprise an engineered wood panel such as an oriented strand board (OSB) panel. A panel of the invention can further comprise a resin glueline layer between the overlay layer and the bottom panel layer.

In one aspect, described herein is a method for making a structural panel comprising applying an uncured resin glueline to an overlay with the resin glueline facing a textured surface, applying a panel or panel pre-cursor to the overlay, and curing the resin glueline facing the textured surface thereby forming a textured resin surface layer on the overlaid panel. The textured surface can be a screen on a conveying device or a textured conveying surface, or the like. A panel pre-cursor can be, for example, an unconsolidated OSB mat of oriented wood strands and an uncured binding formulation. A method of the invention can further comprise pressing and curing a panel pre-cursor simultaneously with curing the resin glueline facing the textured surface. A method of the invention can further comprise applying a resin glueline between the surface of the overlay facing the panel or panel pre-cursor and the panel or panel pre-cursor.

Provided herein in an example embodiment is an engineered wood structural panel sheathing factory-laminated with an alternative underlayment (see, e.g., ZIP System® roof sheathing for commercially available product; www.huberwood.com/main.aspx?pagename=zipsystemroofOverview) with a higher coefficient of friction for better anti-slip properties. The same technology could be applied to other panels, such as a water-resistive membrane factory-bonded to wood-based structural sheathing, used as water-resistive barriers (e.g., ZIP System® wall sheathing; www.huberwoods.com/main.aspx?pasgename=zipsystemwalloverview) to increase the slip-resistant properties of the wall sheathing.

Additional advantages and aspects will be set forth in part in the description which follows, and in part will be obvious from the description, or may be learned by practice of the aspects described below. The advantages and aspects described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below. Like numbers represent the same elements throughout the figures.

FIG. 1 shows a graph of the measured average coefficient of friction for several materials from Example 1 (A=example embodiment of present invention; B=TriFlex 30® synthetic roofing underlayment; C=experimental formulation 1 overlaid roofing panel with grit; D=experimental formulation 2 overlaid roofing panel with grit; E=commercial plywood; F=Titanium™ UDL synthetic roofing underlayment; control=ZIP System® commercial roofing panel).

FIG. 2 shows a cross section of an example embodiment of a commercial overlaid panel such as the control in FIG. 1.

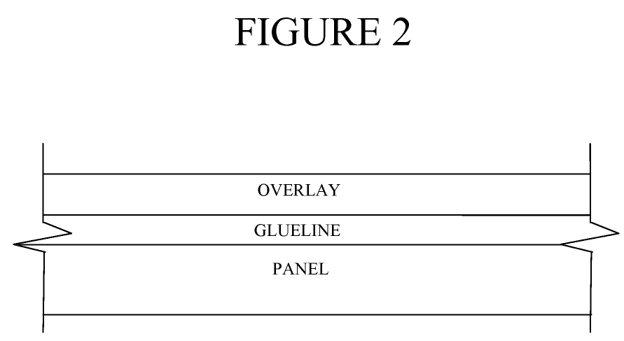

FIG. 3 shows a cross section of a first example embodiment of an overlaid panel of the invention.

FIG. 4 shows a cross section of a second example embodiment of an overlaid panel of the invention.

### DETAILED DESCRIPTION

Before the present compositions, articles, and/or methods are disclosed and described, it is to be understood that the aspects described below are not limited to specific embodiments; specific embodiments as such may, of course, vary. It is also to be understood that the terminology used herein is for the purpose of describing particular aspects only and is not intended to be limiting.

In this specification and in the claims which follow, reference will be made to a number of terms which shall be defined to have the following meanings:

It must be noted that, as used in the specification and the appended claims, the singular forms “a,” “an,” and “the” include plural referents unless the context clearly dictates otherwise. Thus, for example, reference to “an adhesive” includes mixtures of adhesives, and reference to “a texture” includes two or more such textures, and the like.

“Optional” or “optionally” means that the subsequently described event or circumstance may or may not occur, and that the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

Disclosed herein is an overlaid structural engineered wood panel, e.g., ZIP System® overlaid roof or wall panel, with much-enhanced slip resistance relative to current commercial panels. This can be achieved by applying a resin glueline on the “screen side” of the overlay, instead of only on the side of the overlay towards the wood component of the panel, as in the current ZIP System® overlaid panel product line.

The overlay of current commercial ZIP System® panels has a resin-impregnated paper and a resin glueline to adhere the overlay to the wood panel. In normal manufacture of current commercial ZIP System® panels, the overlay is placed onto the board-forming equipment with the resin glueline towards the wood mat/furnish that is pressed into the board.

Current commercial Example—Panel with overlay installed, where resin glueline is between the paper overlay and the wood material of the panel:

Layer 1—resin-impregnated kraft paper overlay
Layer 2—Resin glueline applied to overlay (10 mils)—for example
Layer 3—wood material to be compressed into a wood panel (e.g., OSB mat)

In contrast, for the present invention, the overlay paper is placed with a glueline layer that is on the overlay away from the wood side, towards, for example, the screen that conveys the mat into the press and the pressed board out of the press. The glueline between the overlay and screen could have the same or different thickness and composition as the current commercial overlaid panel glueline, and the regular glueline between the wood portion and the overlay could have the same or different thickness and composition as the glueline of the current commercial overlaid panel and/or the glueline between the overlay and screen of the present invention.

### EXAMPLE EMBODIMENT 1

### Panel with Overlay Installed, with Resin Glueline Towards the Screen (Away from the Wood)

Layer 1—Resin glueline applied to overlay (e.g., 10 mils)
Layer 2—resin-impregnated kraft paper overlay
Layer 3—wood material to be compressed into a wood panel (e.g., OSB mat)

Surprisingly, the adhesive of the glueline on the top did not stick to the press and other process equipment as would be expected.

A glueline placed towards the screen will conform to the screen pattern much more than the resin-impregnated paper of the overlay alone could conform. The shape/texture of the glueline after being pressed into the screen pattern is very slip-resistant and has a higher coefficient of friction than the overlay without the resin glueline between the overlay and the screen.

An advantage of a panel of the present invention is that it may also reduce the slipping of the mat on the screens during manufacturing, which are used to convey the mat and overlay to the press. The overlay used in the prior art (ZIP System® roof and wall) has some instances when there is a problem with the screen slipping under the overlay and mat, especially in the acceleration stage of the forming line, before going into the pre-loader.

Another advantage of this invention is that it can be cost-competitive with the current commercial ZIP System® overlaid sheathing product lines. In the search for an improved slip-resistant product, it is desirable to add as little cost to the current product as possible. The present invention would add little or no cost to the materials and/or the processing equipment in the current manufacturing facilities.

### A. Compositions/Articles

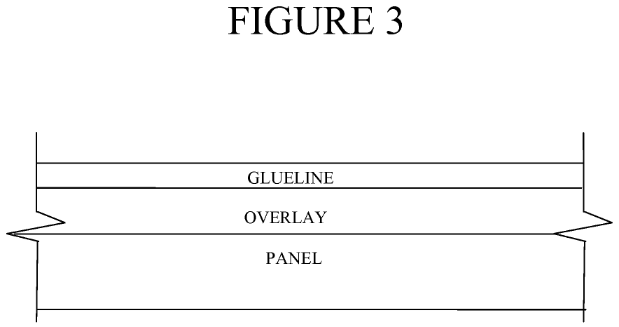

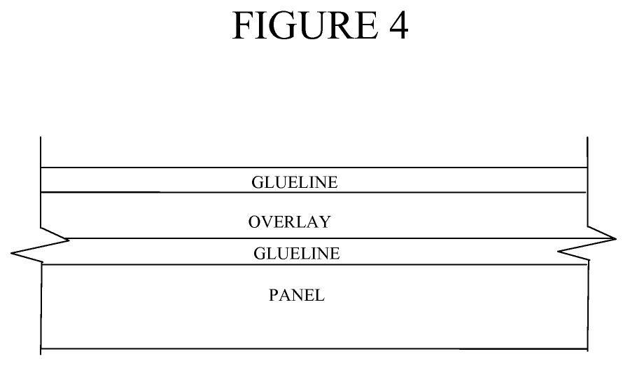

In one aspect, described herein are compositions and/or articles comprising a structural panel with an improved coefficient of friction. A structural panel with an improved coefficient of friction comprises a textured resin top surface layer, an overlay layer, and a bottom panel layer. See, e.g., FIG. 3. The textured resin top surface layer comprises a resin glueline with an imprinted texture effective to increase the COF relative to panels without the top textured resin surface layer. The overlay layer can comprise a resin-impregnated overlay web material. The bottom panel layer can comprise an oriented strand board (OSB) panel. A panel of the invention can further comprise a resin glueline layer between the overlay layer and the bottom panel layer. See, e.g., FIG. 4.

An example commercial overlaid panel is a ZIP System® panel such as sold by Huber Engineered Woods LLC, Charlotte, N.C. and illustratively described in U.S. Pat. No. 6,737,155 and U.S. Published Patent Applications U.S. 2005/0229524, U.S. 2005/0257469, and U.S. 2005/0229504, the disclosures of which are hereby incorporated by reference in their entireties for their teachings on conventional known overlaid structural panels, their component materials, and methods of and equipment for making them. These panels comprise an OSB panel, a resin-impregnated overlay, and a glueline between the panel and the overlay.

A panel of the invention comprises a panel or a panel pre-cursor. A panel can be, for example, an OSB panel or other engineered wood panel. It is believed that a fully formed panel can be made to have a higher COF by utilizing the principles of the present invention; however, embodiments of the invention have only been manufactured with panel pre-cursors (e.g., OSB mat comprising oriented wood and a binding formulation) which have then been pressed and cured simultaneously with the textured resin glueline top layer. Examples of compositions and methods for making panels and panel pre-cursors are known in the art generally and specific examples can be found in, e.g., U.S. Pat. No. 6,737,155 and U.S. Published Patent Applications U.S. 2005/0229524, U.S. 2005/0257469, and U.S. 2005/0229504. One of ordinary skill in the art can readily determine appropriate compositions and methods for a panel or a panel pre-cursor for use in the present invention.

A panel of the invention comprises an overlay. An overlay can, for example, be resin-impregnated kraft paper. A resin-impregnated kraft paper can comprise a partially cured resin. Examples of compositions and methods for making an overlay are known in the art generally and specific examples can be found in, e.g., U.S. Pat. No. 6,737,155 and U.S. Published Patent Applications U.S. 2005/0229524, U.S. 2005/0257469, and U.S. 2005/0229504. One of ordinary skill in the art can readily determine appropriate compositions and methods for an overlay for use in the present invention.

A panel of the invention can comprise an adhesive or glueline. The glueline can be located on one or both surfaces of the overlay (or on the panel between the panel and overlay). Example glueline adhesives are conventional resins used in the manufacture of engineered wood panels such as OSB and include isocyanate and/or phenolic based resins such as 4,4, diphenylmethane-diisocyanate (MDI) and phenol-formaldehyde (PF). The resin is one which is effective for removal from process equipment during and after manufacturing of the final panel. The whole panel or portion(s) of the panel can comprise the textured glueline. The glueline is in an amount effective to form an imprint or texture on the surface of the overlaid panel, when made according to the present invention, wherein the imprint or texture on the surface produces a measured COF greater than that of conventional overlaid panels or bare panels. Examples of compositions, thicknesses, methods for applying the glueline are known in the art generally and specific examples can be found in, e.g., U.S. Pat. No. 6,737,155 and U.S. Published Patent Applications U.S. 2005/0229524, U.S. 2005/0257469, and U.S. 2005/0229504. One of ordinary skill in the art can determine appropriate compositions and methods for forming an appropriate glueline for use in the present invention.

The PF resin in the glueline tested in an example embodiment of the invention released from metal of the conveyor screens and press platens without any adhesion issues.

A panel of the invention comprises an imprint or texture. An imprint can be in a glueline. The imprint of texture is one which is effective to increase the COF relative to conventional overlaid panels or bare panels. The imprint or texture can be produced, for example, by a glueline being between the overlay and a textured surface during production, such as that resulting from conveying screens in OSB manufacturing. Thus, a panel of the invention comprises a textured, resin-coated overlay. The COF of a panel of the invention can be, for example, about 1.1 or greater (as measured using a English XL Variable Incidence Tribometer (VIT) and following ASTM F1679), specifically for example about 1.1, 1.12, 1.15, 1.17, 1.175, 1.18, 1.19, or 1.2. In a specific example embodiment, the COF can be about 1.175. Examples of methods and equipment for texturing the glueline are known in the art generally and specific analogous examples for texturizing only a resin-impregnated overlay can be found in, e.g., U.S. Pat. No. 6,737,155 and U.S. Published Patent Applications U.S. 2005/0229524, U.S. 2005/0257469, and U.S. 2005/0229504. One of ordinary skill in the art can determine appropriate methods for forming an appropriate imprint or texture in the glueline in the present invention.

A panel of the invention can be, as discussed above, located on one or both surfaces of the overlay (or on the panel between the panel and overlay). These gluelines can be, for example, of various thicknesses.

### EXAMPLE EMBODIMENTS 2, 3

### Panel with Overlay Installed, where Overlay has Resin Glueline on Both Sides of Overlay

Layer 1—Resin glueline applied to overlay (e.g., 5 mils)
Layer 2—resin-impregnated overlay
Layer 3—Resin glueline applied to overlay (e.g., 5 mils)
Layer 4—wood material to be compressed into a wood panel
—or—
Layer 1—Resin glueline applied to overlay (e.g., 7 mils)
Layer 2—resin-impregnated overlay
Layer 3—Resin glueline applied to overlay (e.g., 3 mils)
Layer 4—wood material to be compressed into a wood panel

The glueline towards the panel can improve adhesion of the overlay to the panel; the glueline toward the screen improves skid resistance/COF. The glueline towards the screen will conform to the screen pattern much more than the overlay alone could conform. The shape of the glueline after being pressed into the screen pattern is very slip-resistant and has a higher coefficient of friction than the overlay without the resin glueline between the overlay and the screen (as shown below in Example 1).

### B. Methods

Described herein are methods for making compositions and/or articles of the invention. A method for making a structural panel comprises applying an uncured resin glueline to an overlay with the glueline facing a textured surface, applying a panel or panel pre-cursor to the overlay, and curing the glueline facing the textured surface thereby forming a textured resin surface layer on the overlaid panel. The textured surface can be a screen on a conveying device or a textured conveying surface, or the like. A panel pre-cursor can be, for example, an unconsolidated OSB mat of oriented wood strands and an uncured binding formulation. A method of the invention can further comprise pressing and curing a panel pre-cursor simultaneously with curing the resin glueline facing the textured surface. A method of the invention can further comprise applying a resin glueline between the surface of the overlay facing the panel or panel pre-cursor and the panel or panel pre-cursor.

In present manufacture of overlaid panels, the overlay is placed onto the board-forming equipment or the panel with the resin glueline towards the wood substance that is pressed into the board. By contrast, for the present invention, the overlay paper is placed with a layer of glueline that is on the overlay surface away from the wood side towards the screen that conveys the mat into the press and the pressed board out of the press. An example is a conventional overlay with a conventional glueline applied and “flipped upside down” before placement on the panel or panel pre-cursor, i.e., facing away from rather than toward the panel or panel pre-cursor.

Examples of methods and equipment for production of overlaid panels are known in the art generally and specific examples for a resin-impregnated overlay with a glueline located only between the overlay and panel can be found in, e.g., U.S. Pat. No. 6,737,155 and U.S. Published Patent Applications U.S. 2005/0229524, U.S. 2005/0257469, and U.S. 2005/0229504. One of skill in the art can utilize these example teachings for methods of and equipment for applying a glueline to the top of the panel/overlay combination or to the top of the combination and between the panel and overlay.

### C. Utility

In one aspect, the panels of the invention can be used like conventional panels, in particular, roofing sheathing.

Though the invention is described with roofing panels in mind, other uses for overlaid panels with increased COF would be readily apparent to one of ordinary skill in the art.

### EXAMPLES

The following examples are put forth so as to provide those of ordinary skill in the art with a complete disclosure and description of how the compositions, articles, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of process conditions, e.g., component concentrations, desired solvents, temperatures, pressures and other process ranges and conditions that can be used to optimize the product obtained from the described process. Only reasonable and routine experimentation will be required to optimize such process conditions.

### Example 1

### Proof of Concept

A panel was made in the Huber Engineered Woods LLC manufacturing plant using the normal ZIP System® panel resin-impregnated overlay sheet with a glueline applied but, instead, the overlay/glueline was applied in an “upside-down” configuration to the forming mat as in Example embodiment 1 and FIG. 3. The finished panels were left to equilibrate in the testing lab to ambient lab temperature and relative humidity.

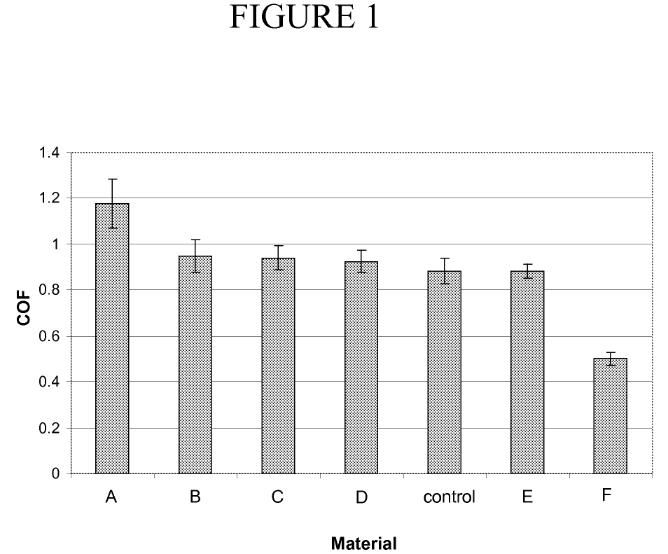

The coefficient of friction (COF) was tested using the English XL Variable Incidence Tribometer (VIT) (aka slipmeter) by following ASTM F1679 Test Method for Using a Variable Incidence Tribometer (VIT) and the manufacturer's directions. [ASTM Standard: ASTM F1679 Test Method for Using a Variable Incidence Tribometer (VIT), American Society for Testing and Materials, 100 Bar Harbor Drive, West Conshohocken, Pa. 19428.] The measured mean COF is summarized below and in FIG. 1, with the “Glueline ‘up’” label indicating the invention.

TABLE 1
Comparative COF measurements.

| | Mean | | |
|---|---|---|---|
| Level | COF | StDev | N |
| Glueline “up” (modified ZIP System ® panel of | 1.175 | 0.1061 | 2 |
| invention) | | | |
| Tri-Flex 30 ® (synthetic underlayment) | 0.95 | 0.0707 | 4 |
| 70# paper coated overlay | 0.94 | 0.0528 | 20 |
| (experimental modified ZIP System ® panel | | | |
| w/grit) | | | |
| 90# paper coated overlay | 0.925 | 0.0473 | 20 |
| (experimental modified ZIP System ® panel | | | |
| w/grit) | | | |
| Control (commercial ZIP System ® roof panel) | 0.8813 | 0.0567 | 24 |
| Plywood (bare) | 0.8813 | 0.0315 | 4 |
| Titanium ™ (synthetic underlayment) | 0.5 | 0.0289 | 4 |

The commercial ZIP System® roof panel was retrieved prior to shipping in the normal condition that it would be available commercially to purchasers.

The experimental modified ZIP System® panel w/grit were made in the lab by addition of grit to a conventional ZIP System® roofing panel. One utilized 70# kraft paper in the overlay, and the other utilized 90# kraft paper in the overlay.

Tri-Flex 30® is a polypropylene-based underlayment formulated for skid resistance commercially available from Grace Construction Products (W.R. Grace & Co.—Conn., Cambridge Mass.; http://www.graceathome.com/pages/roofingprod.htm#TRIFLEX). It was purchased “off-the-shelf” for this comparative testing. Titanium™ UDL is a synthetic polymer underlayment with anti-slip nodular surface commercially available from Interwrap, Inc. (Mission, BC, Canada; http://interwrap.com/dev/). It was purchased off-the-shelf for this comparative testing. Standard plywood was purchased off-the-shelf for this comparative testing.

Throughout this application, various publications are referenced. The disclosures of these publications in their entireties are hereby incorporated by reference into this application in order to more fully describe the compositions and methods described herein.

Various modifications and variations can be made to the compositions and methods described herein. Other aspects of the compositions and methods described herein will be apparent from consideration of the specification and practice of the compositions and methods disclosed herein. It is intended that the specification and examples be considered as exemplary.

What is claimed is:

1. A panel comprising
an engineered wood panel substrate bottom layer,
an overlay comprising resin-impregnated web, and
a textured adhesive glueline top layer,
wherein the panel has an improved coefficient of friction (COF) relative to conventional overlaid panels or bare panels without the adhesive glueline top surface layer.

2. The panel of claim 1 further comprising a glueline between the engineered wood panel substrate bottom layer and the overlay comprising resin-impregnated web.

3. A structural panel with an improved coefficient of friction (COF) comprising a textured resin top surface layer, an overlay layer, and a bottom panel layer wherein the COF is improved relative to conventional overlaid panels or bare panels without the textured resin top surface layer.

4. A method for manufacturing a panel comprising
applying an uncured resin glueline to an overlay with the resin facing a textured surface,
applying a panel or panel pre-cursor to the overlay, and
curing the resin facing the textured surface thereby forming a textured resin surface layer on the overlaid panel.

5. The method of claim 4 further comprising applying a second resin glueline between the overlay and the panel or panel pre-cursor.
